(19) United States
(12) Patent Application Publication
(10) Pub. No.: US 2002/0166810 A1
(43) Pub. Date: Nov. 14, 2002

(54) Filtration cartridge end cap

(76) Inventors: Thomas L. LeBlanc, Mendon, MA (US); Ralph Stankowski, westford, MA (US)

Correspondence Address: Kevin S. Lemack, Nields & Lemack, Suite 8, 176 E. Main Street, Westboro, MA, 01581, US

(21) Appl. No.: 09/850,807

(22) Filed: May 8, 2001

(51) Int. Cl. B01D 27/08

(52) U.S. Cl. 210/450

(57) ABSTRACT

Filter cartridge or housing construction for filtering a fluid medium such as a slurry having a filtration medium, and one or more end caps therefor. One end of the cartridge of this invention is sealed with a cap having a fluid inlet while the opposing end is sealed with a cap having a fluid outlet. The present invention provides an end cap design for a filter cartridge or housing that reduces the number of parts previously required for such end caps. In addition, once the end caps of the invention are assembled to the filter housing, they cannot be removed without destroying the housing and/or cap, thereby ensuring a permanent assembly.

The present invention relates to a filter used for filtering particle-containing or slurry-like materials. More particularly, it relates to a filter cartridge end cap.

### BACKGROUND OF THE INVENTION

Filter cartridges including separations means such as a depth filter for filtering a slurry which effectively removes undesirably large solid particles and gels are used in various applications including photoresist chemicals, biopharmaceutical products and abrasive materials for the semiconductor industry. Photoresist chemical compositions often contain gels and agglomerates of gels which are formed from the photoresist chemical due to shear, shock or age of the chemicals. Such gels and agglomerates need to be removed prior to using these chemical compositions. Biopharmaceutical liquid compositions such-as cell broths, fermentation liquids, transgenic milks and other transgeric liquids, blood, blood fractions or other bacterial or animal fluids or secretions, contain whole cells, cell components, fats and other solids which need to be removed to in order to further process and recover desired components of these compositions. One particular application is for slurry compositions utilized in CMP to polish wafers in VLSI and ULSI integrated circuit devices. High pH silica CMP slurries are utilized to polish dielectric and polysilicone layers. In addition, acidic silica and alumina or metal/metal oxide abrasive based slurries are utilized to polish metal interconnects. The CMP process uses submicron (30-500 nm) abrasive particles at a typical concentration of 1-30% by weight particles.

The typical specification for commercial CMP slurries includes percent solids, pH, specific gravity, mean particle size and general (bulk) particle size distribution. However, a small number of “large” particles (>1 um) have been found which fall outside of the specified size distribution. These particles can be aggregates, agglomerates or gels and may be formed from agglomeration, settling, system or pH shock or local drying of slurry. The large particles and agglomerates can cause microscratches and they, together with the gels cause other defects on planarized wafer surfaces during CMP processing. Slurry filtration to remove these relatively large particles has proven to be beneficial in reducing wafer defects and increasing yields in CMP processes.

At the present time a wide variety of filter cartridge constructions are utilized to purify fluids. These cartridge constructions are designed to remove solids and colloidal particles as well as microorganisms. The basic two separate and distinct types of cartridges used in filtration of gases and liquids are depth filters (typically wound) and surface or screen filters (usually pleated). A depth filter is primarily used to remove most of the contaminants and particles. It is typically utilized upstream of a surface or screen filters. The most important properties for a depth filter are its “dirt holding capacity” or throughput, pressure drop and retention. The filter design allows contaminants and particles to be trapped in stages within the depth of the filter due to the construction of the multiple layers of various media types. A wound depth filter has multiple layers with the most open media (largest micron retention rating), i.e., largest pore size usually the outermost layer, adjacent the liquid inlet with the tightest media at the core adjacent the liquid outlet will have the least amount of surface area due to the smallest diameter around which it is wrapped. The layer at the core contributes to most of the pressure drop of the cartridge because the media has the highest pressure drop and the least amount of filtration surface area. Likewise, this layer will significantly reduce the capacity of the filter due to both the low filtration surface area and the smallest micron retention rating.

As disclosed in U.S. patent application Ser. No. ______, the disclosure of which is hereby incorporated by reference, one particular filter cartridge includes a housing and end caps which are sealed to the housing by means of O-rings. The end caps can be attached to the housing by any conventional means such as by screwing to the housing. One of the end caps is provided with an inlet and the other end cap is provided with an outlet. A plurality of stacks of filter sheets are positioned within the housing separated by annular spacers throughout the height of the housing not occupied by the end caps. Each of the sheets comprises a filter medium. The interior of the housing is a free of open volumes. That is, it is completely filled with the stack of filter sheets separated by annular spaces having an open central volume.

It would be desirable to simplify the assembly of the filter cartridge or housing by reducing the number of parts. It would be further desirable to provide a filter housing that ensures a permanent assembly.

### SUMMARY OF THE INVENTION

The present invention comprises a filter cartridge or housing construction for filtering a fluid medium such as a slurry having a filtration medium, and one or more end caps therefor. In a preferred embodiment of the present invention, one end of the cartridge of this invention is sealed with a cap having a fluid inlet while the opposing end is sealed with a cap having a fluid outlet. The present invention provides an end cap design for a filter cartridge or housing that reduces the number of parts previously required for such end caps. In addition, once the end caps of the invention are assembled to the filter housing, they cannot be removed without destroying the housing and/or cap, thereby ensuring a permanent assembly.

It is therefore an object of the present invention to provide a filter cartridge for filtering a fluid medium such as a slurry composition, which cartridge comprises a hollow housing having a first end including an inlet and a second end including an outlet, said hollow housing being filled with a filter medium such as a depth filter and being free of an open void volume upstream of said depth filter, said cartridge being sealed by one or more end caps.

It is another object of the present invention to provide an end cap for a filter cartridge.

### BRIEF DESCRIPTION OF THE DRAWINGS

FIG. 1 is a perspective view of an end cap for a filter cartridge in accordance with the present invention;

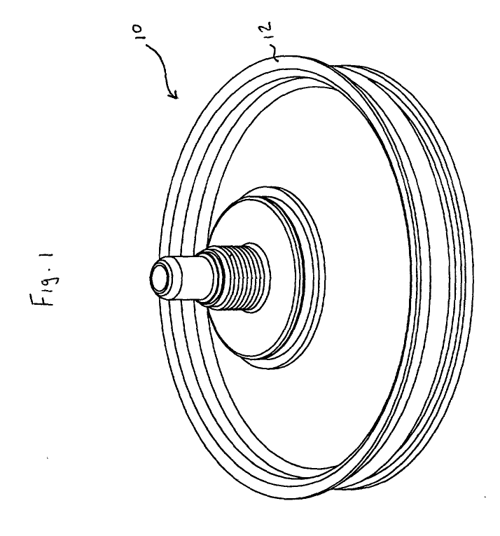

FIG. 2 is a side view of an end cap for a filter cartridge in accordance with the present invention;

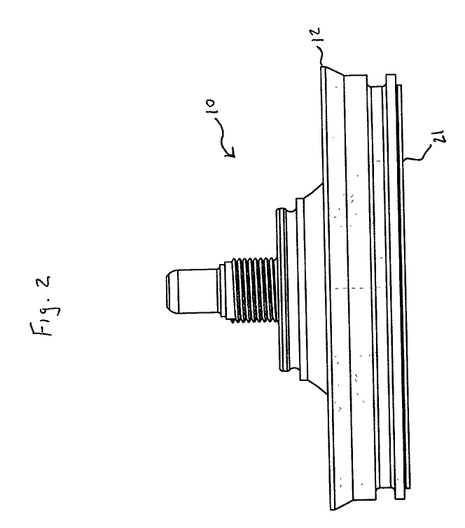

FIG. 3 is a cross-sectional view of an end cap for a filter cartridge in accordance with the present invention;

FIG. 4 is a cross-sectional view of the end cap shown assembled to a filter cartridge in accordance with the present invention;

FIG. 5 is a perspective view of a filter cartridge adapted to receive the endcap of FIG. 1 in accordance with the present invention;

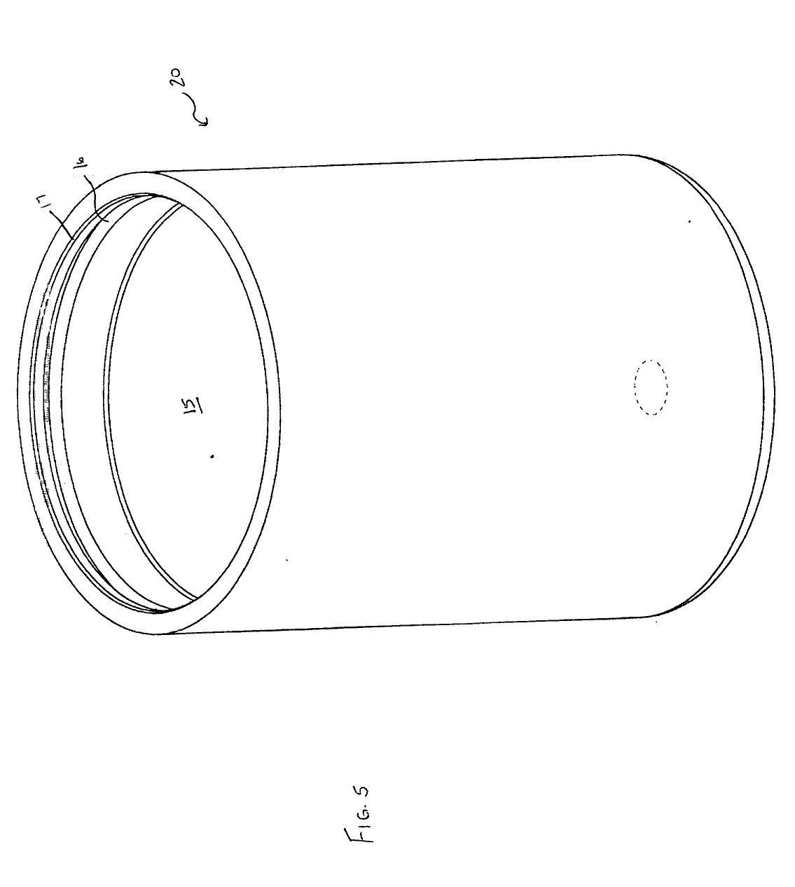

FIG. 6 is a cross-sectional view of a portion of the filter cartridge of FIG. 5 in accordance with the present invention;

FIG. 7 is a perspective view of an end cap for a filter cartridge in accordance with an another embodiment of the present invention; and

FIG. 8 is a perspective view of a filter cartridge adapted to receive two end caps of FIG. 1 in accordance with the present invention.

### DESCRIPTION OF THE SPECIFIC EMBODIMENTS

The present invention provides an end cap, preferably for use with a filter cartridge construction which comprises (1) a depth filter comprising either (a) a wound depth filter, (b) a stack of depth filters or (c) a cylindrical seamless fibrous depth filter formed from a fibrous mass of fibers. The depth filter has a thickness in the direction of fluid flow there through of between about 1 and about 18 inches, preferably between about 3 and about 12 inches to attain effective retention of undesirably large particles while permitting passage there through of particles within a desired size range. However, those skilled in the art will appreciate that the invention is not limited to any particular filter type or configuration.

Representative slurries which can be filtered in accordance with this invention include CMP slurries such as silica-based slurries, alumina-based slurries, ceria-based slurries, diamond-based slurries, manganese dioxide-based slurries, titanium and other metal or metal oxide slurries. Additionally, representative biological-type slurries in which the filter of this invention can be used include cell broths whether containing whole cells or ruptured cells or cellular components, fermentation products, a transgeric liquid such as transgeric milk, blood, a blood fraction or other slurries which contain large components which need to be separated from smaller components.

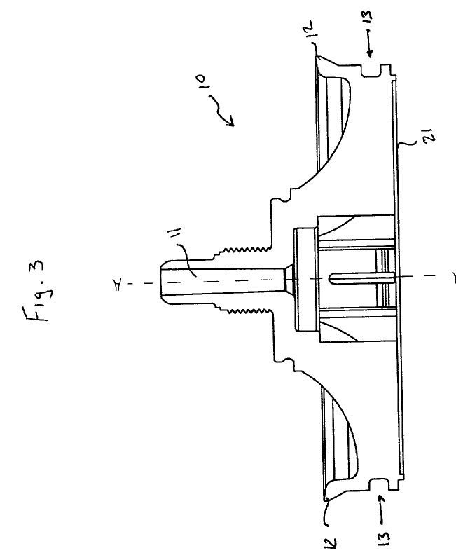

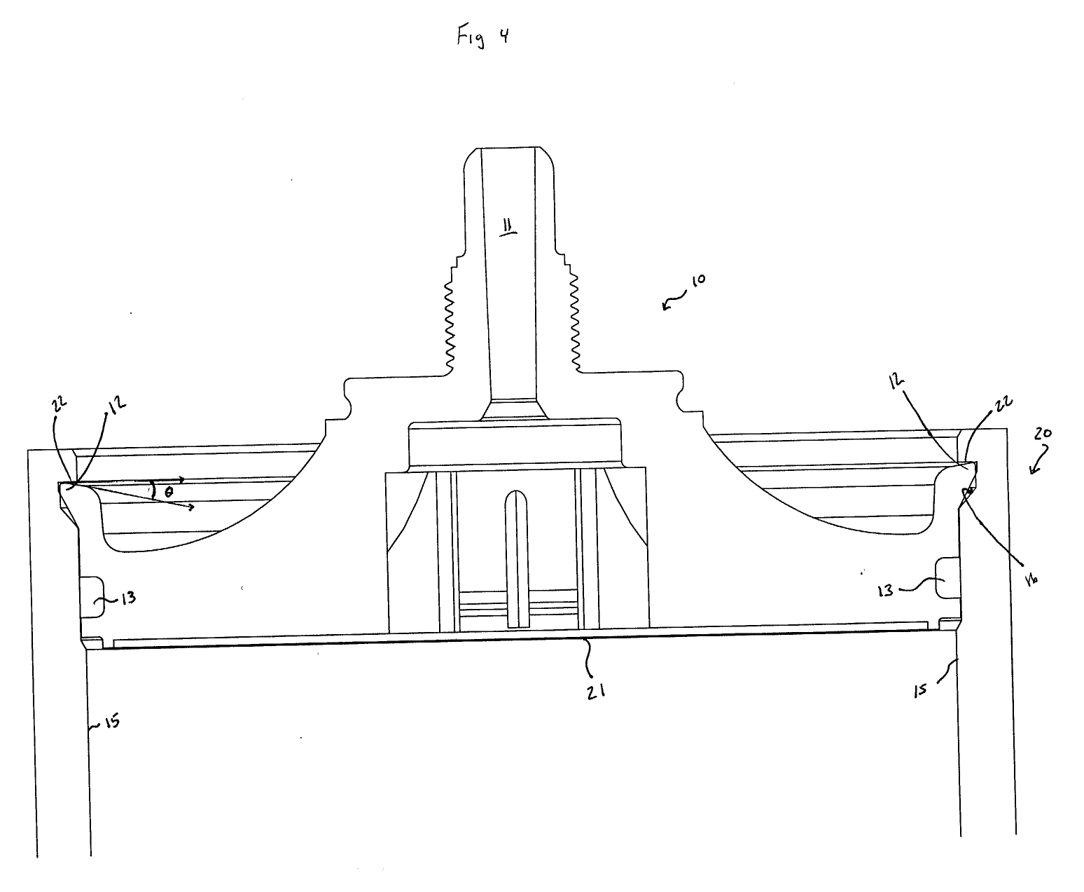

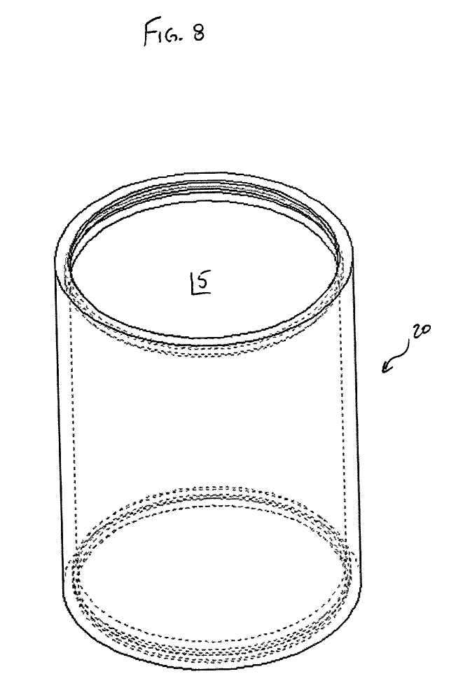

Referring now to the figures, an end cap 10 is shown in accordance with the present invention. One or more end caps 10 can be used in a housing. FIG. 8 shows a housing designed to accommodate two end caps 10. The end cap 10 is provided with a fluid passageway 11 (FIG. 3) which can be an inlet or an outlet, depending upon the location of the end cap on the filter cartridge and depending upon the direction of fluid flow. The end cap 10 includes a tapered lip 12 that is preferably annular and uniformly dimensioned. The lip 12 tapers inwardly towards the longitudinal centerline A-A of the end cap 10 at an angle of about 30°. Below the tapered lip 12 (in the direction towards the cap bottom 21) is an annular slot 13. The slot 13 is dimensioned to receive an O-ring or the like to seal the cap in the cartridge housing, against the inner cartridge wall, for example. As shown in FIG. 4 with the O-ring removed from slot 13, the annular wall of the end cap 10 abuts against the inner wall 15 of the housing 20 so that the O-ring, when in place, will act as a seal to prevent fluid from leaking into or out of the cartridge or housing 20.

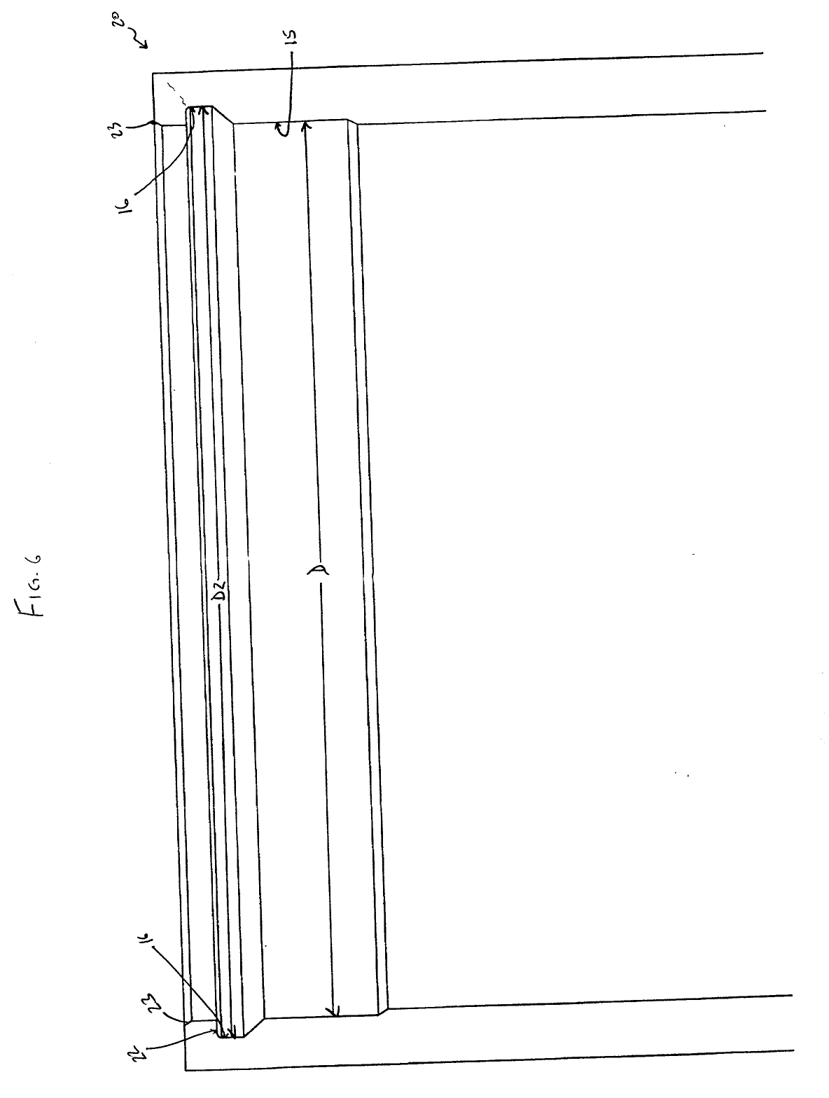

The housing 20 includes an annular inner wall 15 as partially shown in FIG. 4 with the end cap in place, and as seen in FIG. 6 with the end cap removed. The upper portion of the wall 15 preferably has a constant inner diameter D, except at annular groove 16 and optionally at its uppermost section 23. The uppermost section 23 can be chamfered so that the inner diameter is slightly larger than diameter D as shown, to facilitate entry and guidance of the end cap 20. The inner diameter at the annular groove 16 is larger than diameter D to accommodate the annular lip 12 of the endcap as discussed in greater detail below. The annular groove 16 is configured to receive the tapered lip 12 of the end cap 10. The groove 16 is designed to receive the tapered lip 12 in a locking engagement, so that it is difficult or impossible to remove the end cap 10 (without damaging it or the housing 20) once the end cap 10 is installed in the housing 20.

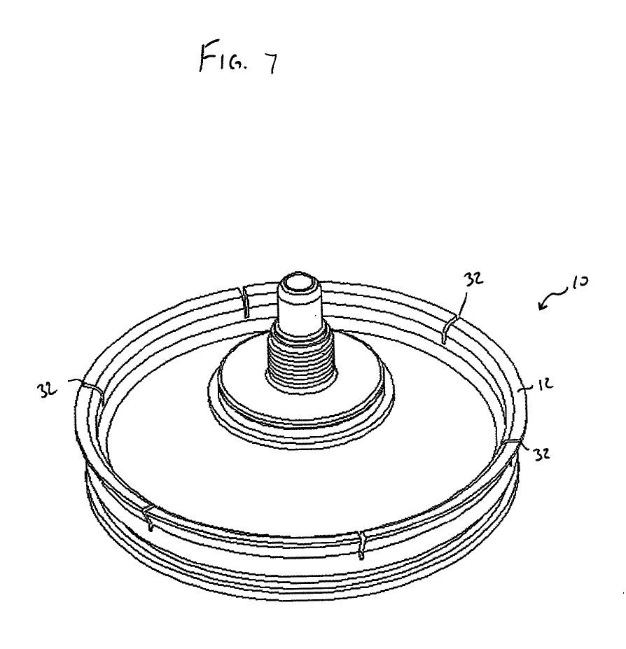

More specifically, insertion of the end cap 10 into the housing 20 is carried out as follows. The annular lip 12 has a diameter larger than the inner diameter D of the housing 20, and in a preferred embodiment, preferably slightly larger than the inner diameter D2 measured at the groove 16 of the housing 20 so that an interference fit is created and the annular lip biases against the housing 20. The end cap 10 and sleeve are preferably made of a flexible material, such as nylon, PVC, PVDF, or a polyolefin, preferably polypropylene or polyethylene. Alternatively, at least the annular lip 12 of the end cap 10 is made of such a material, so that when the end cap 10 is inserted into the housing, the annular lip 12 contacts the inner wall 15 of the housing 20 and flexes or bends to enable the end cap to be inserted into the housing. Alternatively still, the housing could be made of the flexible material. The chamfer at 23 in the housing 20 facilitates this process. In addition, one or more slots 32 may be formed along the perimeter of the end cap 10 at or in the vicinity of the lip 12 to provide additional flexibility (FIG. 7). Such slots preferably should extend to the radius of the lip. The end cap 10 is forced into the housing 20 a sufficient distance to allow the annular lip 12 to engage the groove 16, where it snaps into place, biasing against the inner annular wall of the groove 16, and locking the end cap 10 into the housing as shown in FIG. 4. In view of the configuration of the annular lip 12 and the groove 16, the annular lip 12 is prevented from moving upwardly (as depicted in FIG. 4) by the shoulder 22 of groove 16.

Accordingly, the preferred end cap 10 construction of this invention comprises a flexible annular lip 12 that is initially compressed upon insertion into the housing 20 by the smaller diameter housing wall 15, until the annular lip snaps into the groove 16 formed in the housing wall 15. An O-ring fits into slot 13 in the end cap 10 to seal the cap in the housing 20. When the end cap 10 is properly inserted and positioned into housing 20, the annular lip 12 abuts against the housing 20 in the groove 16 and prevented from being retracted from the housing by shoulder 22. This construction provides excellent sealing within the housing to prevent leakage from the housing, and is capable of withstanding any pressure it may normally be subjected to.

It is not absolutely necessary that an interference fit be created between the annular lip 12 of the end cap 10 and the housing 20. Thus, there could be some clearance between the annular lip 12 and the housing, as long as the end cap remains in place upon the application of a load.

In order to prevent the annular lip 12 of the end cap 10 from acting as a cam and facilitating slippage out of the groove 16, a reverse angle θ is preferably formed as shown in FIG. 4. A suitable angle θ is from about 0° to about 45°, preferably about 50 to about 20°, most preferably about 10°. Forming the angle also allows the very tip of the annular lip 12, which is preferably a flat, to bite into the corner of the groove 16. Creating a flat in the annular lip 12 also provides more surface area that provides more strength.

The end cap design of the present invention provides several advantages. It is simpler to manufacture and assemble than conventional designs, and eliminates difficult snap ring installations. It ensures a permanent assembly, and requires fewer parts.

Those skilled in the art will appreciate that although a cylindrical housing configuration is disclosed, other configurations are possible as long as the end cap conforms to the housing for sealing engagement therein. The corners in the housing are preferably rounded or radiused to help prevent cracking. The term “annular” as used herein is therefore intended to broadly refer to perimeters which encompass configurations other than cylindrical. In addition, it should be understood that the annular lip of the end cap and the corresponding receiving groove in the housing need not be continuous; one or more lips could be formed which are received in snap-engaging relation in corresponding grooves in the housing.

What is claimed is:

1. A fluid separation assembly, comprising:
a housing having an inner wall and a groove formed therein, the housing having a first inner diameter defined at said groove which is greater than a second inner diameter defined in said housing spaced from said groove;
an end cap for sealing engagement in said housing, said end cap comprising an annular lip having a diameter greater than said first inner diameter and configured to be received by said groove when said end cap is placed in fluid sealing relationship with said housing.

2. The fluid separation assembly of claim 1, wherein said end cap further comprises an annular slot for receiving an O-ring.

3. The fluid separation assembly of claim 1, wherein said end cap further comprises a fluid passageway to allow fluid communication with said housing.

4. The fluid separation assembly of claim 1, wherein said groove comprises a shoulder adapted to prevent removal of said end cap from said housing once said lip is received in said groove.

5. The fluid separation assembly of claim 1, wherein said annular lip of said end cap comprises one or more slots.

6. The fluid separation assembly of claim 1, wherein said annular lip is angled about 10° relative to horizontal.

7. A fluid separation assembly, comprising:
a housing having a housing inner wall and a groove formed therein, said groove having a groove inner wall and a shoulder;
an end cap sealing engaged in said housing, said end cap comprising an annular lip biasing against said groove inner wall and abutting against said shoulder so as to prevent removal of said end cap from said housing.

8. The fluid separation assembly of claim 7, wherein said end cap further comprises an annular slot containing an O-ring for sealing against said housing inner wall.

9. The fluid separation assembly of claim 7, wherein said end cap further comprises a fluid passageway to allow fluid communication with said housing.

10. The fluid separation assembly of claim 7, wherein said annular lip comprises one or more slots.
